(19) United States
(12) Patent Application Publication
(10) Pub. No.: US 2007/0278749 A1
(43) Pub. Date: Dec. 6, 2007

(54) U-PACKING AND FLUID PRESSURE SINGLE ACTING CYLINDER

(76) Inventors: Nobuhiro NAKANISHI, Minokamo City (JP); Hiroyuki EMOTO, Kakamigahara City (JP)

Correspondence Address: Michael L. Crapenhoft;c/o Hiroe & Associates, 4-3, Usa 3-chome, Gifu City, 500-8368, JP

(21) Appl. No.: 11/756,608

(22) Filed: May 31, 2007

(30) Foreign Application Priority Data
Jul. 19, 2006 (JP) JP2006-196463
Jun. 1, 2006 (JP) JP2006-153309

(51) Int. Cl. F16J 15/32

(52) U.S. Cl. 277/567

(57) ABSTRACT

A U-packing is fitted externally in a seal grove of a piston of a fluid pressure single acting cylinder to maintain fluid tightness between a bottom side and a rod side of the cylinder. The U-packing has an open side facing the bottom side, and a return hole that allows communication between the open side and a non-open side. The U-packing is movable within the seal groove so that when a working fluid pressure on the bottom side is higher than a working fluid pressure on the rod side, the return hole is closed by structure of the seal groove, and when the working fluid pressure on the rod side is higher than the working fluid pressure on the bottom side, the return hole is opened. Working fluid leaked from the bottom side into the rod side can thus be returned to the bottom side of the cylinder.

### BACKGROUND OF THE INVENTION

The present invention relates to a U-packing externally fitted in a seal groove of a piston of a fluid pressure single acting cylinder. The U-packing maintains fluid tightness between a bottom side and a rod side partitioned by the piston. The invention relates as well to a fluid pressure single acting cylinder provided with this U-packing.

A fluid pressure single acting cylinder is known among fluid pressure cylinders that use oil pressure or hydraulic pressure. A working fluid is supplied only to the bottom side of the piston to generate a linear driving force. In such a fluid pressure single acting cylinder, in order to prevent leakage of the working fluid to the rod side on the opposite side from the bottom side at which the working fluid should act, a U-packing is used for maintaining fluid tightness between them.

An example of a known fluid pressure single acting cylinder with such a U-packing will be described below in connection with FIG. 7. FIG. 7 is a sectional view illustrating a fluid pressure single acting cylinder using the U-packing. Such a cylinder is described in described in Japanese Patent Application Publication No. 2003-49806.

The fluid pressure single acting cylinder 30 comprises a cylinder body 25, a piston 26 that slides in a fluid tight manner within the cylinder body 25, and a piston rod 27 that carries the piston 26 at the tip end of the rod and which outputs a linear driving force generated by the working fluid to the outside of the cylinder.

A seal groove 26a is provided on the outer periphery of the piston 26, with a U-packing 23 maintaining fluid tightness between a bottom-side fluid chamber Ca and a rod-side fluid chamber Cb. These chambers are divided by the piston 26 which includes a seal groove 26a.

The bottom side of the cylinder body 25 is closed by a cylinder head 25a. A passage 25c for communication of the working fluid is provided at the cylinder head 25a. The rod side of the cylinder body 25 is closed by a cylinder head 25b, from which the piston rod 26 projects slidably in a fluid tight manner.

The fluid pressure single acting cylinder 30 receives working fluid at the bottom-side fluid chamber Ca. The working fluid drives the piston 26 upward in this figure. The piston 26 is lowered by when pushed by a load applied to the piston rod 27.

The U-packing 23 limits leakage of the working fluid from the bottom-side fluid chamber Ca to the rod-side fluid chamber Cb, but such leakage cannot be fully prevented. Working fluid collected in the rod-side fluid chamber Cb prevents the piston 26 from reaching its normal upper limit of motion.

The fluid pressure single acting cylinder 30 is therefore provided with a check mechanism 28 for returning working fluid collected in the rod-side fluid chamber Cb back to the bottom-side fluid chamber Ca as the piston 26 nears the upper limit of its motion.

The check mechanism 28 includes fluid passages 28a, 28b, and 28c between the piston 26 and the piston rod 27 from the rod-side fluid chamber Cb to the bottom-side fluid chamber Ca on the rod side rather than the U-packing and a check valve 28d at the outlet of the fluid passage 28c to the bottom-side fluid chamber Ca.

The check valve 28d allows communication of the working fluid from the rod-side fluid chamber Cb to the bottom-side fluid chamber Ca when the pressure of the working fluid in the rod-side fluid chamber Cb becomes higher than the pressure of the working fluid in the bottom-side fluid chamber Ca.

In this way, in the fluid pressure single acting cylinder 30 provided with the check mechanism 28, when the piston 26 nears the upper limit of its motion, if the pressure in the working fluid in the rod-side fluid chamber Cb becomes higher than that of the working fluid in the bottom-side fluid chamber Ca, the working fluid in the rod-side fluid chamber Cb is returned to the bottom-side fluid chamber Ca so that the piston 26 can then reach the upper limit of without hindrance.

This type of check mechanism 28 requires the check valve 28d, with a further need to provide the piston 26 and the fluid passages 28a, 28b, 28c at the piston rod 27, which increases the cost of the assembly.

As a solution, one may provide the U-packing with a check function, and such solutions have been described in Japanese Patent Application Publication No. 49-49330; Japanese Utility Model Application Publication No. 59-51232; Japanese Utility Model Utility Model Application Publication 6-51658; and Japanese Patent Application Publication No. 8-35504.

However, these devices cannot be used under severe conditions in which there is an extreme difference between the pressures in the rod-side fluid chamber Cb and the bottom-side fluid chamber Ca, as is the case with devices that use the present invention.

### SUMMARY OF THE INVENTION

The present invention was made in order to solve the above problem and has as an object to provide a U-packing that is externally fitted in a seal groove of a piston of a fluid pressure single acting cylinder and which can exert a check function under a severe environment so that fluid tightness is maintained between the bottom side and the rod side divided by the piston. The invention also provides a fluid pressure single acting cylinder that uses the U-packing.

The U-packing of the present invention is a U-packing externally fitted in the seal groove of the piston of the fluid pressure single acting cylinder. The U-packing maintains fluid tightness between the bottom side and the rod side, which are divided by the piston. The U-packing is configured so that an opening side of the U-packing faces the bottom side. A return hole allows the opening side to communicate with the non-opening side. The U-packing is movable within the seal groove so that if the working fluid pressure on the bottom side (hereinafter referred to as “positive pressure”) is higher than the working fluid pressure on the rod side (hereinafter referred to as “back pressure”), the return hole is closed by a rod-side side wall of the seal groove, while if the back pressure is higher than the positive pressure, the return hole is opened with respect to the rod-side side wall.

Also, the fluid pressure single acting cylinder of the present invention is characterized in that the U-packing is used.

Since the U-packing of the present invention is externally fitted in the seal groove of the piston of the fluid pressure single acting cylinder, the return hole is provided at the U-packing to maintain fluid tightness between the bottom side and the rod side partitioned by the piston, and a check function is exerted by opening and closing of the return hole through movement of the U-packing within the seal groove. The check function can thus be performed even under severe conditions.

Also, since the fluid pressure single acting cylinder of the present invention uses the above U-packing, the effect of the U-packing is performed in the cylinder.

### BRIEF DESCRIPTION OF THE DRAWINGS

FIGS. 1A-1E show an example of a U-packing of the present invention, in which FIG. 1A is a front view, FIG. 1B is a sectional view, FIG. 1C is a sectional view of an essential part of a fluid pressure single acting cylinder using the U-packing, FIG. 1D is an enlarged view of a packing portion of FIG. 1C, and FIG. 1E is an enlarged view illustrating a state in which the U-packing is moved to the bottom side.

FIGS. 2A-2C show another example of the U-packing, in which FIG. 2A is a front view, FIG. 2B is a sectional view, and FIG. 2C is a sectional view of an essential part of a fluid pressure single acting cylinder that uses the U-packing.

FIGS. 3A-3C show another example of the U-packing, in which FIG. 3A is a front view, FIG. 3B is a sectional view, and FIG. 3C is a sectional view of an essential part of a fluid pressure single acting cylinder that uses the U-packing.

FIGS. 4A-4E show an example of a seal structure of the present invention, in which FIG. 4A is a front view of a backup ring constituting the seal structure, FIG. 4B is a sectional view of its essential part, FIG. 4C is a front view of a U-packing constituting the seal structure, FIG. 4D is a sectional view of its essential part, and FIG. 4E is a sectional view of an essential part of the backup ring of another example.

FIG. 5A is a sectional view of an essential part of the fluid pressure single acting cylinder using the seal structure of FIGS. 1A to 1D, and FIGS. 5B-5E are explanatory views of the check function of the seal structure.

FIG. 6A is a front view of a U-packing constituting another example of the seal structure of the present invention, FIG. 6B is a sectional view of its essential part, FIG. 6C is affront view of an essential part explaining the check function of the seal structure, and FIG. 6D is a sectional view of FIG. 6C.

FIG. 7 is a sectional view illustrating a previously known fluid pressure single acting cylinder using a conventional U-packing.

### DETAILED DESCRIPTION OF PREFERRED EMBODIMENTS

Embodiments (examples) of the present invention will be described below referring to the attached drawings.

### EXAMPLE 1

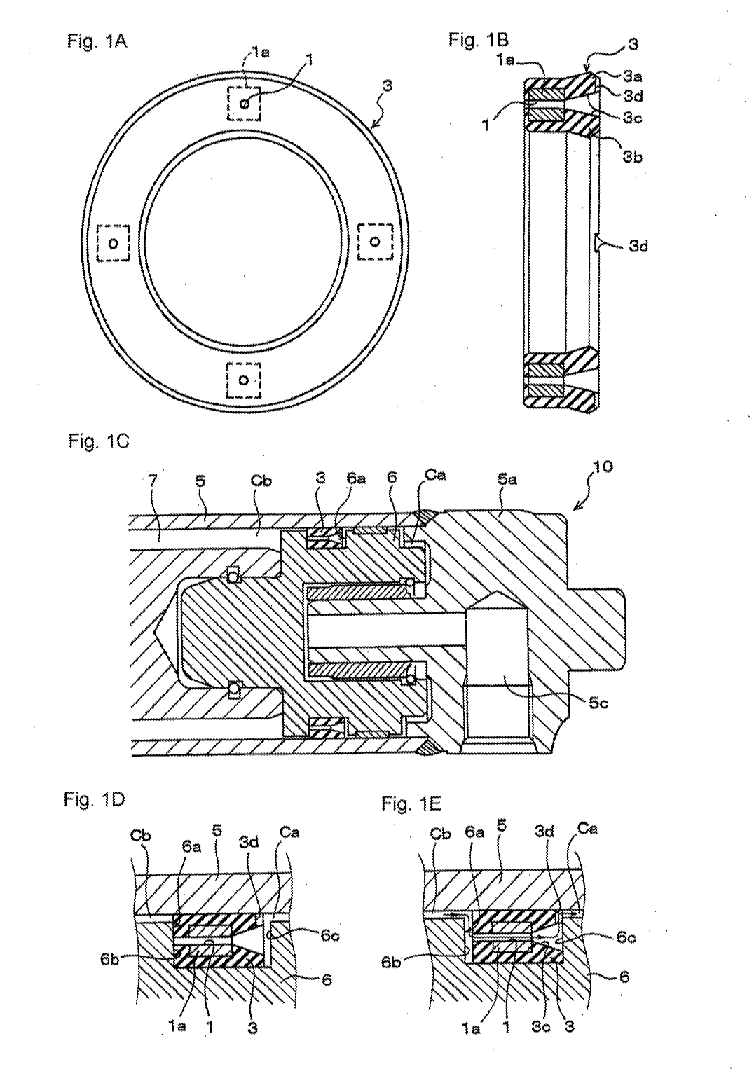

FIG. 1 shows an example of the U-packing of the present invention, in which FIG. 1A is a front view, FIG. 1B is a sectional view, FIG. 1C is a sectional view of an essential part of the fluid pressure single acting cylinder using the U-packing, FIG. 1D is an enlarged view of the U-packing part in FIG. 1C, and FIG. 1E is an enlarged view of a state where the U-packing has been moved to the bottom side in comparison with FIG. 1D.

A U-packing 3 shown in FIGS. 1A and 1B has the form of a ring with a substantially U-shaped cross section cut in a plane passing through the U-packing's center. The U-packing includes an outer lip portion 3a and an inner lip portion 3b. A return hole 1 allows the open side of the U-shaped cross-section to communicate with the non-open side.

An opening portion 3c forms a space between the outer lip portion 3a and the inner lip portion 3b. The return hole 1 has allows a non-open side of the U-packing 3 to communicate with the opening portion 3c on the open side.

Return holes 1 at positions spaced equally around the circumference of the non-open side. The return hole 1 is maintained open by a rigid return-hole forming body 1a, which is embedded within and not exposed at the surface of the rubber molding that forms the U-packing 3.

The return hole 1 should preferably be maintained even if the return hole forming body 1a is deformed or the like when the U-packing 3 is used under high pressure conditions.

The return hole forming body 1a is a rectangular solid with the return hole 1 extending between the center portions of two opposite faces.

A fluid recess groove 3d which allows the working fluid in the return hole 1 and the opening portion 3c to communicate to the outer periphery side of the U-packing 3 is formed at an appropriate place at the edge in the axial direction of the outer lip portion 3a.

The material of the U-packing 3 is preferably the same material as that of a normal U-packing. The material should allow the U-packing to fit into the groove under normal conditions, but should be sufficiently flexible and expandable to allow the U-packing to be moved over the outer diameter of the piston at the time of the U-packing's installation into the groove. It should also preferably be a material that allows the outer lip portion 3a to be brought fully into contact with the inner peripheral surface of the cylinder, with the inner lip portion 3b in contact with the bottom peripheral face of the groove, so that a fluid-tight seal is formed against the positive pressure (referring to the pressure of the working fluid acting on the opening side). Suitable materials may include polyurethane, which is a rubber synthetic resin (including PU, TPU, PUR), nitrile rubber (NBR), a thermoplastic elastomer (TPE), or the like.

The U-packing 3 is used in the fluid pressure single acting cylinder 30 as shown in FIG. 1C, with the fluid pressure single acting cylinder 10 being used, for example, to elevate a fork of a forklift. The cylinder comprises a cylinder body 5, a piston 6 that slides within the cylinder body 5 in a fluid tight manner, and a piston rod 7 with the piston rod 6 at one end and the other end projecting outside the cylinder body 5 for applying a linear driving force to an external load.

Both sides of the cylinder body 5 are closed by cylinder heads with a cylinder head 5a on the bottom side being visible in FIG. 1C. A passage 5c is provided at the cylinder head 5a to allow passage of the working fluid.

A seal groove 6a is provided on the outer periphery of the piston 6. The U-packing 3 of the present invention is fitted in the seal groove 6a so that the open side faces the bottom side (the bottom-side fluid chamber Ca side). Fluid tightness is thereby maintained between the cylinder body 5 and the piston 6, in other words, the fluid tightness between the bottom-side fluid chamber Ca and the rod-side fluid chamber Cb separated by the piston 6.

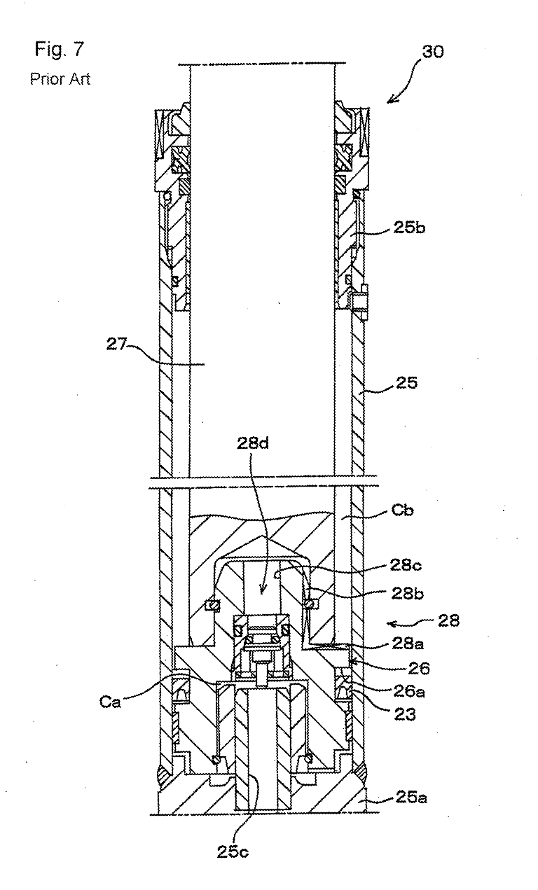

The basic functions of the cylinder body 5, the piston 6, the piston rod 7, and the like are the same as those of the corresponding elements of the fluid pressure single acting cylinder 30 described above in FIG. 7, and the detailed description will be omitted.

There is a predetermined gap in the axial direction of the piston 6, that is, in the slide direction between the seal groove 6a and the U-packing 3. A pressure difference between the working fluid in the bottom-side fluid chamber Ca and the working fluid in the rod-side fluid chamber Cb moves the U-packing 3 provided with the return hole 1 in the axial direction within the seal groove 6a, thereby exerting the check function. This function will be described below in connection with FIGS. 1D and 1E.

FIG. 1D shows a state at a time before the piston 6 reaches its maximum travel during driving. At this time, the pressure of the working fluid in the bottom-side fluid chamber Ca (positive pressure) is higher than the pressure of the working fluid in the rod-side fluid chamber Cb (back pressure). This pressure difference holds the non-open side end face of the U-packing 3 in contact with a rod-side wall surface 6b of the seal groove 6a, and the return hole 1 is thus blocked and closed by the rod-side wall surface 6b.

In this state, the U-packing 3 maintains a fluid tight seal between the bottom-side fluid chamber Ca and the rod-side fluid chamber Cb, and the working fluid does not flow from the bottom-side fluid chamber Ca to the rod-side fluid chamber Cb.

FIG. 1E shows a state in which the piston 6 has been extended further than that depicted in FIG. 1D, one in which the piston is nearing its maximum degree of extension out of the cylinder. As the working fluid that has leaked into the rod-side fluid chamber Cb is enclosed in the rod-side fluid chamber Cb, which is gradually getting smaller, the pressure in the rod-side fluid chamber (back pressure) at some point becomes higher than the pressure of the working fluid in the bottom-side fluid chamber Ca (positive pressure).

At this time, the open-side end face of the U-packing 3 is brought into contact with a bottom-side wall face 6c of the seal groove 6a by the pressure difference, and a gap is opened between the non-open-side end face and the rod-side wall face 6b, which in turn opens the return hole 1.

Therefore, in this case, the working fluid in the rod-side fluid chamber Cb is returned to the bottom-side fluid chamber Ca through the return hole 1 of the U-packing 3, the opening portion 3c, and the fluid recess groove 3d, and the piston 6 can rise to the maximum without undue hindrance.

That is, the U-packing 3 provided with the return hole 1 of the present invention can achieve a required check function despite the simple configuration in which only the return hole 1 is provided, and in addition, the check mechanism 28, which is indispensable in the fluid pressure single acting cylinder 30 in FIG. 7 in the background art, is not needed any more, and the cost and complexity of the mechanism is thereby reduced.

In other words, the U-packing 3 of the present invention can perform a full and sufficient check function under a severe environment, when the U-packing is externally fitted in the seal groove 6a of the piston 6 of the fluid pressure single acting cylinder 10. The U-packing also maintains the required fluid tightness between the bottom side (Ca) and the rod side (Cb), which are separated by the piston 6.

A fluid pressure single acting cylinder 10 that uses this improved U-packing 3 benefits from this improved configuration.

In the U-packing 3 of the present invention, moreover, since the return hole 1 for realizing the check function is formed and ensured by the rigid return hole forming body 1a, patency of the return hole 1 can be ensured even under the severe conditions of an extremely high-pressure difference between the working fluids in the rod-side fluid chamber Cb and the bottom-side fluid chamber Ca, and the reliability of the check function is thereby ensured.

### EXAMPLE 2

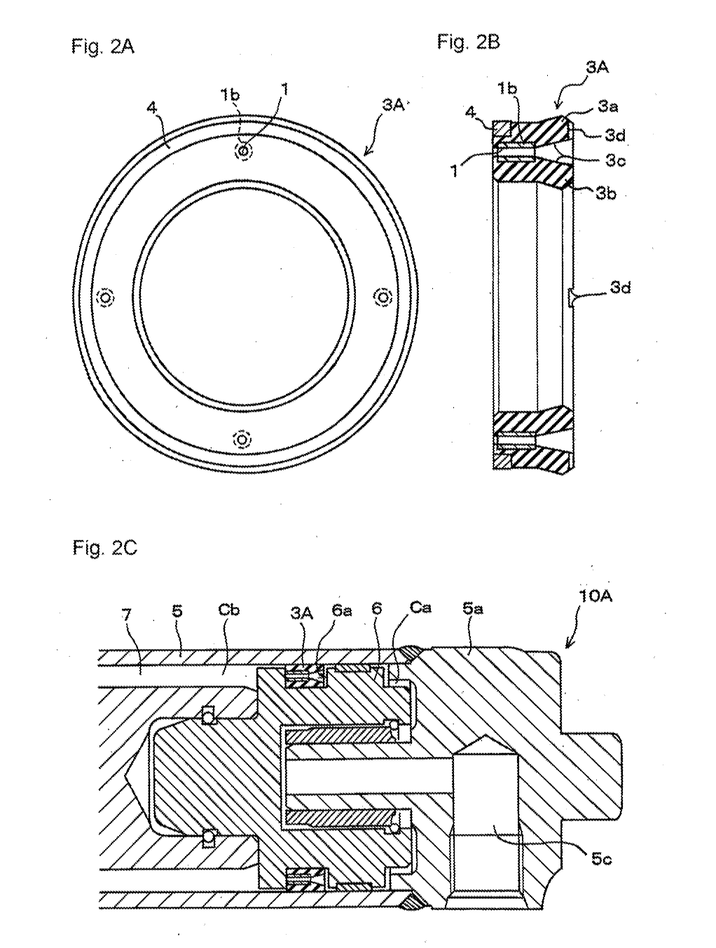

FIGS. 2A-2C show another example of the U-packing of the present invention, in which FIG. 2A is a front view, FIG. 2B is a sectional view, and FIG. 2C is a sectional view of an essential part of the fluid pressure single acting cylinder that uses the U-packing. In the following description, parts corresponding to those that have already been described will be given the same reference numerals and duplicated explanation of those parts will be omitted.

The U-packing 3A is different from the U-packing 3 in FIG. 1 in that a backup ring 4 is fitted at the outer periphery of the non-open side.

They also differ in that the return hole forming body 1b is not a rectangular solid as in FIG. 1, but is instead in the form of a short tube or pipe. The return hole forming body need only ensure the patency of the return hole 1, and be rigid enough so that it is not deformed under pressure. These functions do not depend strongly on the exterior shape of the return hole forming body. The working effect in this embodiment is the same as that of FIG. 1.

The backup ring 4 is bias-cut at an angle across the ring so that the backup ring can be expanded over the piston when it is fitted into the seal groove. The U-packing 3A is first fitted into the seal groove 6a of the piston 6 without the backup ring 4. The backup ring is then fitted in combination with the outer peripheral non-opening side of the U-packing 3A.

The backup ring 4 is formed of a rigid material and serves to prevent deformation of the U-packing 3A under high pressure so that the seal function of the U-packing 3A is more securely ensured. The deformation preventing function also helps to maintain the patency of return hole 1 under high pressure conditions.

Therefore, according to the U-packing 3A, in addition to the basic function of the U-packing 3, the seal function and the check function can be exerted more fully and sufficiently.

FIG. 2C is a fluid pressure single acting cylinder 10A that uses the U-packing 3A. The fluid pressure single acting cylinder 10A thus benefits from the effect of the U-packing 3A.

### EXAMPLE 3

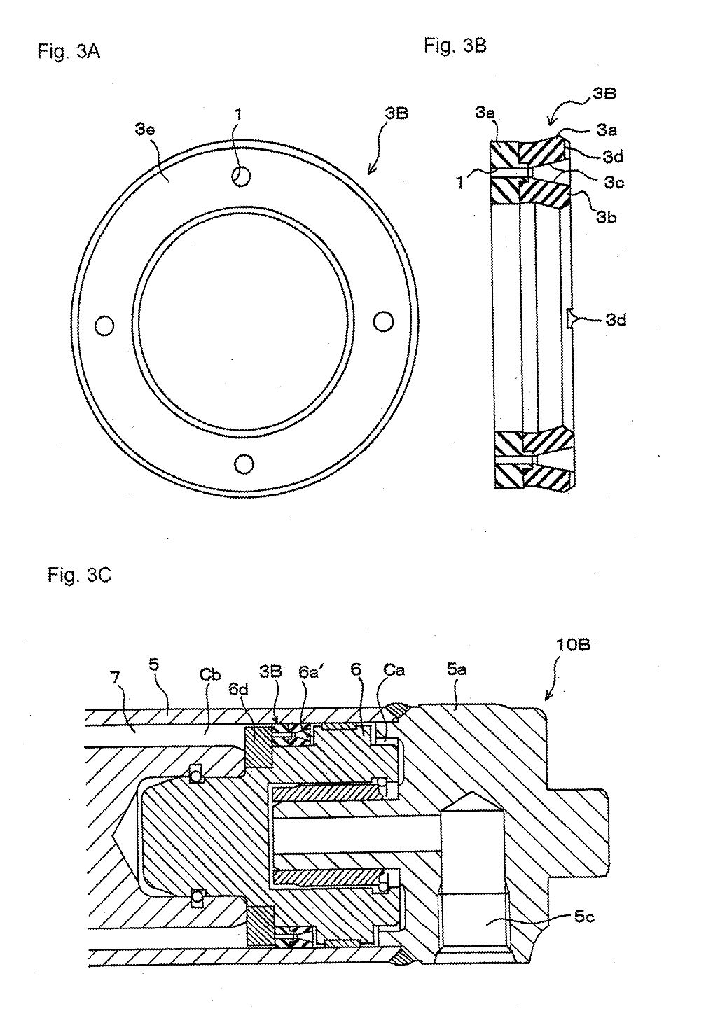

FIGS. 3A-3C show another example of the U-packing of the present invention, in which FIG. 3A is a front view, FIG. 3B is a sectional view, and FIG. 3C is a sectional view of an essential part of the fluid pressure single acting cylinder that uses the U-packing.

The U-packing 3B is like the U-packing 3 in FIG. 1 in that it is produced from the same material as that of the U-packing 3 in FIG. 1, but different in that the non-open side is made as a rigid portion 3e, which is formed of a more rigid material and integrally molded as a whole.

The return hole 1 has its major part formed at the rigid portion 3e so as to maintain its shape under a high pressure and to ensure that the return hole 1 remains open.

Since the rigid portion 3e is rigid and can not be expanded to be fit into place, a seal groove 6a′ of the piston 6 has its rod-side side wall portion made as a detachable ring body 6d, and when this U-packing 3B is to be attached, the ring body 6d is removed, the U-packing 3B is the fitted, and the ring body 6d is returned to the original position after that.

Since this U-packing 3B is provided with the rigid portion 3e where the return hole 1 is formed, it performs the same function as that of the U-packing 3 of FIG. 1, also performing similarly to the U-packing 3A provided with the backup ring 4 of FIG. 2.

FIG. 3C shows a fluid pressure single acting cylinder 10B that uses the U-packing 3A. This fluid pressure single acting cylinder 10B thus benefits from the effect of the U-packing 3B.

The U-packing and the fluid pressure single acting cylinder of the present invention are not limited to the above-described embodiments. Various variations and combinations are possible within the range described in the claims and other alternative embodiments not specifically described here.

A seal mechanism not with the U-packing alone, but instead with the U-packing and the backup ring combined, is described below. This configuration performs the check function under severe conditions similarly to the above-mentioned U-packing. Here, too, the U-packing is externally fitted in the seal groove of the piston of the fluid pressure single acting cylinder so as to maintain fluid tightness between the bottom side and the rod side, which are divided by the piston. A seal mechanism that performs the check function on the backup ring side and a fluid pressure single acting cylinder that uses this seal mechanism are described below.

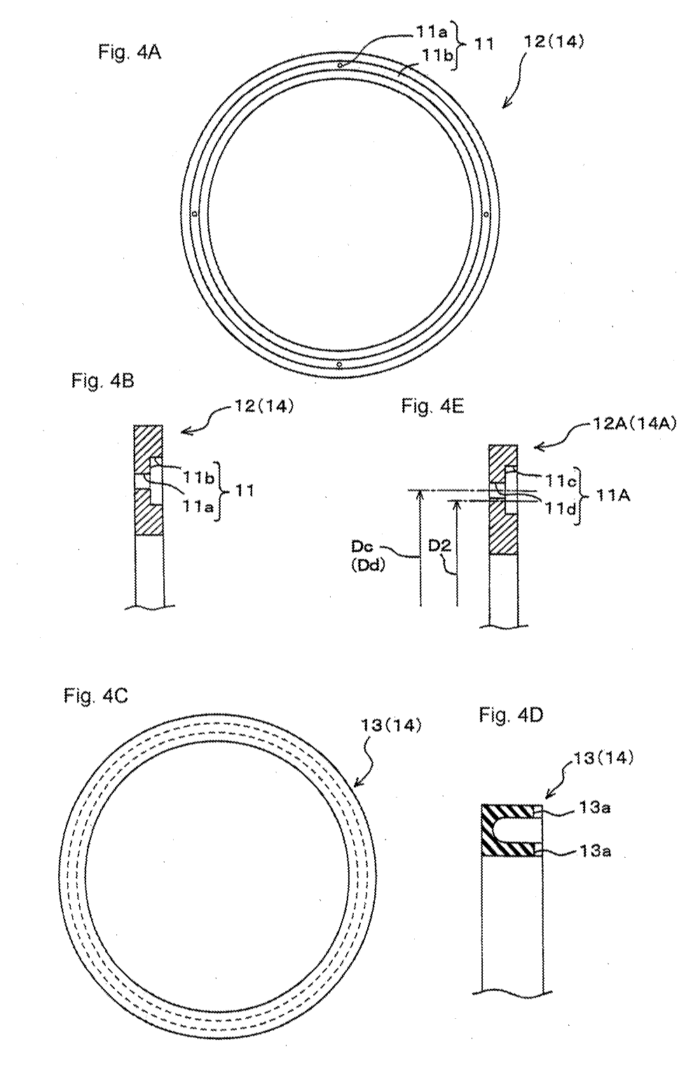

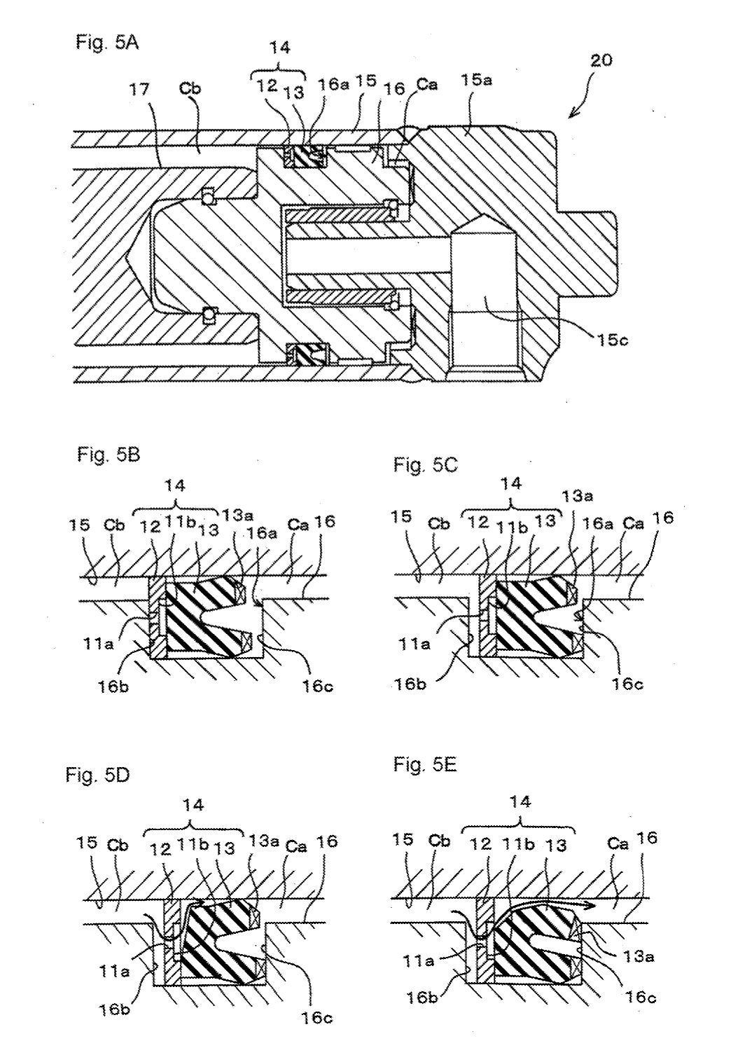

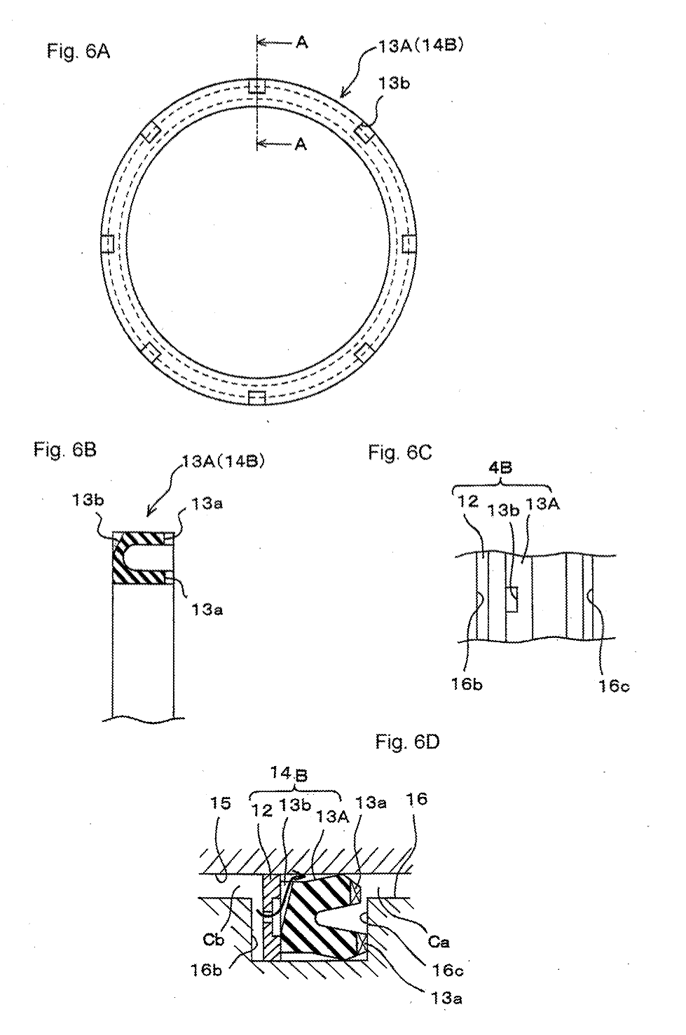

In the following description, reference numerals of the components in the invention described in Japanese Patent Application No. 2006-196493, which is the second basis of priority claimed by the present application are cited simply by changing “1” to “11”, “2” to “12 . . . “7” to “17” and “10” to “20” and drawing numerals from “FIG. 1” to “FIG. 4”, “FIG. 2” to “FIG. 5” and “FIG. 3” to “FIG. 6” without any other alteration.

FIG. 4 of the original application is not used.

Japanese Patent Application Publication No. 2003-49806 describes a seal groove of a piston in the fluid pressure single acting cylinder, in which a U-packing and a backup ring are combined, but this seal mechanism does not perform a check function.

As a method to solve this problem, the U-packing constituting the seal structure or the backup ring aiding it may be provided with the check function, but there has not been a seal structure as a whole provided with the check function by giving the check function to the backup ring.

The present invention was made in order to solve the above problem and has an object to provide a seal structure which can exert the check function as a whole by giving the check function to the backup ring side, and a fluid pressure single acting cylinder using this seal structure.

The seal structure of the present invention comprises a U-packing externally fitted in a seal groove of a piston of a fluid pressure single acting cylinder for maintaining fluid tightness between a bottom side and a rod side partitioned by the piston, and a backup ring externally fitted on the rod side of the U-packing. The backup ring is provided with a fluid passage that enables communication of a working fluid from the rod side of the seal groove to the U-packing side of the backup ring when a fluid pressure on the rod side of the piston becomes higher than that on the bottom side. The fluid passage comprises a through hole penetrating in the width direction of the backup ring and an annular groove communicating with the through hole and provided on the side face on the U-packing side of the backup ring.

A fluid pressure single acting cylinder uses the above seal structure.

The seal structure of the present invention comprises the U-packing at the seal groove of the piston of the fluid pressure single acting cylinder for maintaining fluid tightness between the bottom side and the rod side, which are separated by the piston, and the backup ring externally fitted on the rod side of the U-packing. The backup ring is provided with a fluid passage that enables communication of the working fluid from the rod side of the seal groove to the U-packing side of the backup ring when the fluid pressure on the rod side of the piston becomes higher than that on the bottom side. The check function is performed by the backup ring.

Since the fluid pressure single acting cylinder of the present invention uses the above seal structure, the cylinder benefits from the effect of this seal structure.

An embodiment (example) of the present invention will be described below using the accompanying drawings.

### EXAMPLE 4

FIGS. 4A-4E show an example of the seal structure of the present invention, in which FIG. 4A is a front view of a backup ring constituting the seal structure, FIG. 4B is a sectional view of its essential part, FIG. 4C is a front view of the U-packing constituting the seal structure, FIG. 4D is a sectional view of its essential part, and FIG. 4E is a sectional view of an essential part of the backup ring. In another example, FIG. 5A is a sectional view of an essential part of a fluid pressure single acting cylinder using the seal structure of FIGS. 4A to 4D, and FIGS. 5B to 5E are explanatory views illustrating a check function of the seal structure.

A backup ring 12 shown in FIGS. 4A and 4B constitutes the seal structure 14 of the present invention in a ring state with a rectangular section as a whole. The backup ring is formed of a rigid material so as not to be deformed even if a high pressure acts on it. The backup ring is used with a U-packing 13 with the main purpose of sealing.

Specifically, as illustrated herein, the backup ring 12 is externally fitted in a seal groove 16a of a piston 16 of a fluid pressure single acting cylinder 20 on the rod side of the U-packing 13 for backup so that the U-packing 13 is not deformed under a high pressure and the seal performance of the U-packing 13 can be exerted to the full extent.

The U-packing 13 shown in FIGS. 4C and 4D is a known one with standard shape and dimensions, whose description will be omitted and constitutes the seal structure 14 of the present invention in combination with the backup ring 12.

A notch groove 13a is provided on the outer periphery side and the inner periphery side of the opening end of the U-packing 13. The notch groove prevents lid pressure breakage.

The backup ring 12 that features the seal structure 14 of the present invention has a fluid passage 11 that enables communication of the working fluid from the rod side of the seal groove 16a to the U-packing 13 side of the backup ring 12 when the fluid pressure on the rod side of the piston 16 becomes higher than that on the bottom side.

The fluid passage 11 has a through hole 11a through the width direction of the backup ring 12 and an annular groove 11b that communicates with the through hole 11a and which is provided on the side face on the U-packing side of the backup ring 12.

The material of the backup ring 12 may be the same as that of a normal backup ring, for example, polytetrafluoroethylene (PTFE), with a rigidity that is not deformed even under the high pressure of the working fluid and used by being separated at a dividing face and fitted in the seal groove 16a.

The backup ring 12 is used as the seal structure 14 in the fluid pressure single acting cylinder 20 shown in FIG. 5A.

The fluid pressure single acting cylinder 20 is used for elevation of forks of a forklift. The cylinder includes the cylinder body 15, a piston 16 that slides within the cylinder body 15 in a fluid tight manner, and a piston rod 17 with the piston 16 at one end and the other end projecting outside the cylinder body 15 to applying a linear driving force to an external load.

Both sides of the cylinder body 15 are closed by a cylinder cover. A cylinder bottom 15a on the bottom side is seen FIG. 5A. A passage 15c is provided at the cylinder bottom 15a for communication of the working fluid.

The seal groove 16a is provided on the outer periphery of the piston 16. The backup ring 12 of the present invention is fitted in the seal groove 16a on the rod side of the U-packing 13 so that the annular groove 11b side becomes the U-packing 13 side, and fluid tightness between the cylinder body 15 and the piston 16, in other words, the fluid tightness between the bottom-side fluid chamber Ca and the rod-side fluid chamber Cb partitioned by the piston 16, is maintained.

Since the basic functions of the cylinder body 15, the piston 16, the piston rod 17, and the like are the same as those of the fluid pressure single acting cylinder 30 described in FIG. 7, further detailed description will be omitted.

The groove width in the axial direction of the seal groove 16a is larger than the thickness of the seal structure 14 to which the backup ring 12 and the U-packing 13 are added to an extent that a predetermined gap is generated in the axial direction of the piston 16, that is, in the slide direction. The pressure difference between the working fluid in the bottom-side fluid chamber Ca and the working fluid in the rod-side fluid chamber Cb moves the backup ring 12 with the fluid passage 11 in the axial direction within the seal groove 16a, along with the U-packing 13, so as to exert the check function. This is described below using FIGS. 5B to 5E.

FIG. 5B shows a state before the piston 16 reaches its maximum travel limit during driving. In this state, the pressure of the working fluid in the bottom-side fluid chamber Ca (positive pressure) is higher than the pressure of the working fluid in the rod-side fluid chamber Cb (back pressure). This pressure difference brings the opposite U-packing 13 side of the backup ring 12 into contact with a rod-side wall surface 16b of the seal groove 16a, and the through hole 11a is closed by the rod-side wall surface 16b.

In this state, the backup ring 12 maintains fluid tightness between the bottom-side fluid chamber Ca and the rod-side fluid chamber Cb along with the U-packing 13, and the working fluid does not flow from the bottom-side fluid chamber Ca to the rod-side fluid chamber Cb.

FIG. 5C shows a state in which the piston 16 has been further extended from that shown in FIG. 5B, at a point near its maximum travel limit. The working fluid that has leaked into the rod-side fluid chamber Cb is enclosed in the rod-side fluid chamber Cb, which is gradually getting smaller as the piston moves outward. The pressure (back pressure) becomes higher than the pressure of the working fluid in the bottom-side fluid chamber Ca (positive pressure).

The opening-side end face of the U-packing 13 thus moves with the backup ring 12 brought into contact with a bottom-side wall surface 16c of the seal groove 16a, while the backup ring 12 side is separated from the rod-side wall surface 16b and the through hole 11a is open.

The working fluid in the rod-side fluid chamber Cb flows, as shown in FIG. 5D, toward the U-packing 13 through the fluid passage 11 of the backup ring 12, that is, through the through hole 11a and the annular groove 11b.

Since the through hole 11a and the annular groove 11b act in the direction on the outer periphery side of the U-packing 13, they can press the outer periphery side of the U-packing 13 more strongly and act to make the outer periphery side of the U-packing 13 bow inward in the end so that a gap is generated between the outer periphery of the U-packing 13 and the inner periphery of the cylinder body 15. As shown in FIG. 5E, the working fluid is returned from the rod-side fluid chamber Cb to the bottom-side fluid chamber Ca, and the piston 16 can reach its maximum travel limit without undue trouble.

The seal structure 14 of the present invention thereby provides the required check function even with the simple constitution in which the fluid passage 11 is provided at the backup ring 12. The check mechanism, which is indispensable in a conventional fluid pressure single acting cylinder is no longer required, and the cost of the assembly can thereby be reduced.

In other words, the seal structure 14 of the present invention can perform the check function by use of the backup ring 12.

A fluid pressure single acting cylinder 20 using the seal structure 14 can thereby benefit from the effect of the seal structure 14 in the cylinder 20.

In the backup ring 12, since the fluid passage 11 can sufficiently exert the above effect only with the through hole 11a, the annular groove 11b does have to be provided in some cases.

### EXAMPLE 5

A backup ring 12A constituting a seal structural body 14A shown in FIG. 4E has different forms of a through hole 11c and an annular groove 11d as compared with the backup ring 12 in FIGS. 4A and 4B.

In this backup ring 12A, a diameter Dc of a hole center circle connecting the centers of multiple through holes 11c is larger than a diameter D2 of the width center circle in the radial direction of the backup ring 12A. The width center circle Dd (=Dc) in the radial direction of the annular ring 11d is also larger than the diameter D2 of the width center circle in the radial direction of the backup ring 12A.

As FIGS. 5B to 5E illustrate, the working fluid from the through hole 11c and the annular groove 11d acts on the further outer periphery side of the U-packing 13, which enhances the bowing effect of the U-packing 13.

With the seal structure 14A configured as described above, the bowing-aiding action of the backup ring 12A the seal structure 14A as a whole can reliably perform the check function, and the fluid pressure single acting cylinder using this seal structure 14A can benefit from having this seal structure 14A inside the cylinder.

It is preferable to provide the through hole 11c and the annular groove 11d so that the working fluid that has passed through these passages acts on the further outer periphery side of the U-packing 13, but when the both are to be provided, only the diameter of the center circle in the radial direction of the annular groove 11d may be made larger without increasing the diameter of the center circle of the through hole 11c.

### EXAMPLE 6

FIG. 6A is a front view of a U-packing constituting another example of the seal structure of the present invention, FIG. 6B is a sectional view of its essential part, FIG. 6C is a front view of the essential part for explaining the check function of the seal structure, and FIG. 6D is a sectional view of FIG. 6C. In the following, the portions that have already been described are given the same reference numerals and duplicate description will be omitted.

In this seal structure 14B, as compared with the seal structure 14 in FIGS. 4A to 4D, the backup ring 12 is common with that in FIGS. 4A and 4B and only the U-packing 13A shown in FIGS. 6A and 6B is different from the U-packing 13 in FIGS. 4C and 4D.

The U-packing 13A, as can be seen in FIGS. 6A and 6B, has, on the non-opening side of the U-packing 13A and on the backup ring 12 side, a radial guide groove 13b for guiding the working fluid flowing from the fluid passage 11 of the backup ring 12 to the outer periphery side.

In the U-packing 13A provided with the guide groove 13b, as shown in FIGS. 6C and 6D, when the pressure of the rod-side fluid chamber Cb (back pressure) becomes higher than the pressure of the working fluid in the bottom-side working chamber Ca (positive pressure), the working fluid which flows from the fluid passage 11 to the U-packing 13A side at movement of the entire seal structure 14B to the bottom side is immediately guided to the outer periphery of the U-packing 13A without being obstructed by the rod-side side face of the U-packing 13A, which can enhance the bowing effect of the outer periphery.

That is, according to the seal structure 14B, by means of the U-packing 13A provided with the guide groove 13b, the check function can be exerted more surely as the entire seal structure 14B by virtue of the bowing aiding action of the U-packing 13A, and the fluid pressure single acting cylinder using the seal structure 14B can exert the effect of the seal structure 14B as the cylinder.

The seal structure and the fluid pressure single acting cylinder of the present invention are not limited to the above embodiments but various variations and combinations are possible within a range described in claims and embodiments.

In a seal structure and the fluid pressure single acting cylinder the opening side of the U-packing is made as the bottom side, and a radial guide groove is provided for guiding the working fluid flowing from the fluid passage of the backup ring to the outer periphery side on the non-opening side of the U-packing and on the backup ring side.

The U-packing of the present invention is externally fitted in the seal groove of the piston of the fluid pressure single acting cylinder and can be used in any industrial field requiring exertion of the check function under the severe environment that the fluid tightness between the bottom side and the rod side partitioned by the piston should be maintained.

The seal structure and the fluid pressure single acting cylinder of the present invention can be used in an industrial field requiring that exertion of the check function as a whole is performed at the backup ring side in the fluid pressure single acting cylinder.

What is claimed is:

1. A U-packing configured to be externally fitted in a seal groove of a piston of a fluid pressure single acting cylinder for maintaining fluid tightness between a bottom side and a rod side separated by the piston, wherein:
the U-packing is configured so that an open side of the U-packing faces the bottom side, a return hole is configured to allow the open side to communicate with a non-open side, and the U-packing is movable within the seal groove so that when a working fluid pressure on the bottom side is higher than a working fluid pressure on the rod side, the return hole is closed by a rod-side side wall of the seal groove, and wherein when the working fluid pressure on the rod side is higher than the working fluid pressure on the back side, the return hole is opened by movement of the U-packing with respect to the rod-side side wall of the seal groove.

2. The U-packing according to claim 1, wherein the return hole is defined by a rigid return hole forming body embedded in a molded material of the U-packing.

3. A fluid pressure single acting cylinder assembly comprising the U-packing according to claim 1 or 2.
